(19) United States
(12) Patent Application Publication
(10) Pub. No.: US 2007/0024649 A1
(43) Pub. Date: Feb. 1, 2007

(54) Method of determining the droplet size of ink droplets released by an ink jet printer

(75) Inventor: Hans Reinten, Velden (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/491,162

(22) Filed: Jul. 24, 2006

(30) Foreign Application Priority Data
Jul. 26, 2005 (EP) 05106848.4

(51) Int. Cl. B41J 2/195

(52) U.S. Cl. 347/7

(57) ABSTRACT

A method of determining the average droplet size of ink droplets released by an ink jet printer. Controlling the droplet speed and droplet size within an ink jet printer is important for maintaining print quality and reliability of the jetting process itself. The invention also relates to an ink jet printer adapted for performing the present method.

This non-provisional application claims priority under 35 U.S.C. §119(a) on European Patent Application No. 05106848.4 filed in European Patent Office on Jul. 26, 2005, which is herein incorporated by reference.

### BACKGROUND OF THE INVENTION

The present invention relates to a method of determining the average droplet size of ink droplets released by an ink jet printer. The present invention also relates to an ink jet printer adapted to perform the present method.

Control of droplet speed and droplet size within an ink jet printer is important for maintaining print quality and reliability of the jetting process itself. Both the droplet speed and the droplet size may drift due to various causes, such as drift in piezo-actuation efficiency, batch variations in ink properties, and temperature drift. For most causes of drift, droplet speed and droplet size are coupled. For this reason, it would be satisfying to solely measure the droplet size. Moreover, the droplet size itself commonly provides other relevant information, such as (among others) information about the print quality. A direct way to measure droplet size is by weighing a large known number of droplets by means of a balance. However, including a balance within an ink jet printer is relatively costly and is commonly undesired from a constructive point of view.

### SUMMARY OF THE INVENTION

It is an object of the present invention to provide an improved method for determining the average droplet size of ink droplets released by an ink jet printer. This object can be achieved by providing a method which comprises the steps of: (a) measuring an amount of ink dosed to at least one ink reservoir of an ink jet printer, said ink reservoir having a substantially predetermined volume, (b) measuring the ink level within said ink reservoir, (c) measuring the number of ink droplets released by at least one nozzle of the ink reservoir, and (d) determining the average ink droplet size based upon the measured values gathered in steps (a)-(c). By generating a material balance, in particular an ink balance, of the ink jet printer as a system with an inlet for ink (ink dosed to the ink reservoir), an outlet for ink (ink released via the nozzle), and an ink container (formed by the ink reservoir itself), different parameters can be obtained during a period of time, based upon which the average droplet size can be calculated by means of an algorithm. Waste-ink created by purging and cleaning the ink reservoir can be compensated for in the present method for example by resetting reference values before actually monitoring the printing process, and in particular the jetting process. The accuracy of the method according to the present invention is dependent on the number of the droplets released by the nozzle(s). Laboratory test results have shown that an average daily use suffices for useful daily information about drift in droplet size. The drift in ink droplet size can therefore be recorded on a daily basis, or, if desired, even more frequently. Based on the information of the average droplet size by counting the drive pulse settings can be adjusted thereby enabling permanent optimization of the print quality and reliability of the printing process. It should be noted that other kinds of information may also be used to adjust the drive pulse settings, such as drift in alignment of print heads in a scanning direction (which may be measured by means of test patterns on a receiving substrate like a sheet of paper), and the number of printer failures due to air entrapment. The information concerning (possible) drift of the droplet size may also be used for adjusting settings related to color management and/or the optical (printing) density (OD). An ink jet printer commonly comprises one or more print heads, each print head containing multiple ink reservoirs, wherein each ink reservoir is provided with at least one nozzle, and more commonly, multiple nozzles, for releasing ink droplets. Hence, preferably the method according to the present invention is applied to the print head or the assembly of print heads as a whole, wherein the print head is considered as being the system as described above, to which, the balance of matter is applied. For a skilled person, it could also be conceivable to consider each ink reservoir and its nozzle(s) as a (micro)system to which the method according to the present invention is applied. However, in practice it is expected that this latter option is less preferable.

In a preferred embodiment the method further comprises step (e) of measuring the number of pressure pulses, in particular activation pulses, to selectively expel the ink droplets via the nozzle, wherein the average ink droplet size is based upon measured values gathered in steps (a) to (c) and e according to step (d). By measuring the number of pressure pulses, in particular activation pulses, an indication can be obtained with respect to the amount of ink droplets released by the nozzle(s) thereby extending, and hence improving the balance of matter, in particular the balance of ink, of the ink jet printer. There are two basic propulsion techniques for the drop-on-demand ink jet printers. One uses a piezoelectric transducer to selectively produce pressure pulses to expel the droplets and the other technique uses thermal energy, usually the momentary heating of a resistor, to produce a vapor bubble in the ink, which during its growth expels a droplet. Either technique uses ink-filled channels or passageways which interconnect with an orifice or nozzle and an ink-filled manifold. The pressure pulse may be generated anywhere in the channels or the manifold. However, the bubble generating resistor (hence the name bubble jet) must be located in each channel near the nozzle.

During step (a) the amount of ink dosed to the ink reservoir is measured by counting the number of ink pellets dosed to the ink reservoir, each pellet having a substantially predetermined and identical volume. In this manner, the ink supply to the ink reservoir can be controlled and dosed relatively accurately. The ink pellets are preferably formed by hot melt ink, that is, an ink which is solid at room temperature but liquid at elevated temperature. For this purpose, the ink is first heated in the inkjet print head to a temperature at which it is liquid, that is, has a consistency such that it can be ejected in the form of small drops by means of the print head.

The ink level within the ink reservoir can be detected by means of different kind of sensors such as a float level indicator, electrical resistance, and a thermal sensor. Preferably, during step (b) the ink level within the ink reservoir is measured by means of at least one thermistor, preferably an NTC thermistor. Application of an NTC thermistor is relatively inexpensive with respect to the application of other types of thermal sensors. However, under specific circumstances it could also be conceivable for a person skilled in the art to apply a PTC type thermistor, or even other kinds of temperature sensitive (electronic) detecting means.

In a preferred embodiment during step (c) the number of ink droplets released by the at least one nozzle of the ink reservoir is measured by counting the number of ink droplets released. To this end, preferably a droplet counter is provided to count the number of ink droplets expelled from the ink reservoir via the nozzles.

The measured values of steps (a)-(c) and step (e), if applicable, are preferably transmitted to a control unit to process these data to calculate the average droplet size according to step d by means of an algorithm stored in the control unit. The control unit, which can function as a computer or as part of a computer, may be programmed to (automatically) adjust subsequently certain specific printer settings, such as the drive pulse settings, the settings related to color management, and/or the settings related to the optical density (OD).

As aforementioned, the ink dosed to the ink reservoirs is preferably formed by hot melt pellets. To melt these ink pellets and to maintain them in a molten state within the ink reservoir, the ink within the ink reservoir is preferably heated. In this manner, the ink contained within the ink reservoir can be easily maintained at an elevated temperature, typically of about 130° Celsius.

The present invention also relates to a computer program embodied in a computer readable medium and comprising computer executed codes adapted for carrying out the method according to the present invention. In this manner, the average ink droplet size (step (d)) can be determined by means of the computer program acting as a software level sensor for performing step (b). The computer program may be embedded within the ink jet printer.

The present invention further relates to a computer adapted to operating the computer program according to the invention. This computer may form part of the ink jet printer according to the invention. The aforementioned control unit may be an integral part of the computer.

Moreover, the present invention relates to an ink jet printer comprising: a print head comprising a plurality of nozzles, and ink channels arranged side by side, each nozzle being connected to an ink reservoir via its associated ink channel; and a device for dispensing ink pellets of substantially predetermined and identical volume to the print head, wherein the ink jet printer further comprises first counting means for counting the number of ink pellets dispensed to the print head, second counting means for counting the number of ink droplets released by the nozzles, detecting means for detecting the ink level within each ink reservoir, and controlling means for determining the average droplet size of ink droplets released by the nozzles based upon measured values gathered by the first counting means, the second counting means, and the detecting means. Preferably though not exclusively, the ink reservoir is provided with multiple nozzles. By means of different sensors and counters a volume balance of ink can be made up, as a result of which the average droplet size of ink droplets released by the nozzles can be determined relatively simplistically, and relatively truthfully and accurately. Advantages of determining the average droplet size in this manner have already been discussed above in a comprehensive manner. In a preferred embodiment the second counting means are adapted for counting the number of pressure pulses produced to expel the ink droplets via the nozzles. In this manner, the jetting process, and hence a (possible) drift in droplet size of ink droplets released via the nozzles can be commonly mapped and even more realistically.

### BRIEF DESCRIPTION OF THE DRAWINGS

The present invention can further be illustrated by the following non-limitative embodiment, wherein:

FIG. 1 shows a perspective view of an ink jet printer according to the present invention.

### DETAILED DESCRIPTION OF THE INVENTION

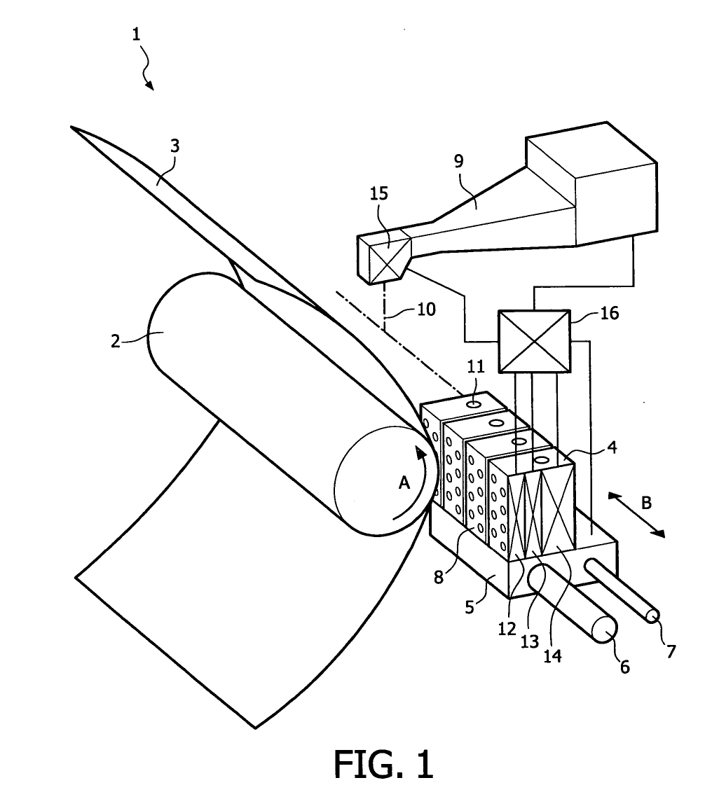

FIG. 1 shows a perspective view of an ink jet printer 1 according to the present invention. In this embodiment the printer 1 comprises a roller 2 to support a substrate 3 and move it along the four print heads 4. The roller 2 is rotatable about its axis as indicated by arrow A. A carriage 5 carries the four print heads 4 and can be moved in reciprocation in the direction indicated by the double arrow B, parallel to roller 2. In this way the print heads 4 can scan the receiving substrate 3, for example a sheet of paper. The carriage 5 is guided over rods 6 and 7 and is driven by means suitable for the intended purpose (not shown). In the embodiment shown in FIG. 1, each print head 4 contains eight ink reservoirs (not shown) connected to eight ink ducts, each with its own nozzle 8, which form two rows of four nozzles 8, each perpendicular to the axis of the roller 2. In a practical embodiment of the printer 1, the number of ink ducts per print head 4, and a number of nozzles 8 per ink reservoir will commonly be many times greater. Each ink duct is provided with means for energizing the ink duct (not shown) and an associated electrical actuation circuit (not shown). In this way, the ink duct, the means for energizing the ink duct, and the actuation circuit form a unit which serves to eject ink drops in the direction of roller 2. If the ink ducts are energized image-wise, an image forms which is built up from ink drops on the substrate 3. When a substrate is printed with a printer 1 of this kind, in which ink drops are ejected from ink ducts, the substrate, or part thereof, is (imaginarily) divided into fixed locations which form a regular field of pixel rows and pixel columns. In one embodiment, the pixel rows are perpendicular to the pixel columns. The resulting separate locations can each be provided with one or more ink drops. The number of locations per unit of length in the directions parallel to the pixel rows and pixel columns is termed the resolution of the printed image, and is indicated, for example, as 400×600 d.p.i. (“dots per inch”). By the image-wise energization of a row of nozzles of the print head of the printer when it moves over a strip of the substrate 3 in a direction substantially parallel to the pixel rows, the row of nozzles being substantially parallel to the pixel columns, as shown in the FIGURE, an image built up from ink drops forms on the substrate 3. In this embodiment, the printer 1 is provided with a number of dispensing devices 9, one for each color, only one being shown in this FIGURE for simplification. With a dispensing device of this kind it is possible to dispense ink pellets at each of the print heads 4. The ink used is a hot melt ink. An ink of this kind is solid at room temperature and liquid at elevated temperature. This ink is dispensed in solid form in each of the print heads whereafter the ink in the print head is melted and brought to operating temperature, typically 130° Celsius. As soon as there is a shortage of liquid ink in one of the print heads, the carriage 5 will be so moved that the relevant print head is disposed beneath the corresponding dispensing device level with dispensing line 10. One or more ink pellets will then be dispensed to the print head, said pellets entering the print head via opening 11. These pellets are then melted and brought to operating temperature. In this way each print head can be provided with sufficient ink at all times. To be able to optimise the printing process, and in particular the print quality determined by multiple factors, such as the optical density (OD), the color management and drive pulse settings, it is important to know and hence to determine the average droplet size of the ink droplets released via the nozzles 8. To this end, the printer 1 according to t the present embodiment, and in particular each reservoir further comprises a counter 12 for counting the number of ink droplets released by the nozzles 8, a counter 13 for counting the number of drive pulses produced, and an ink level sensor 14 (schematically shown). The dispensing device 9 contains a counter 15 for counting the number of ink pellets dispensed. All counters 12, 13, 15 and the ink level sensor 14 are coupled to a control unit 16. Based upon the measured values gathered by the counters 12, 13, 15 and the ink level sensor 14 the average droplet size can be calculated by the control unit 16. The control unit 16 is also adapted to control both the dispensing devices 9 and the printer carriage 5 to timely supply the ink reservoirs with a sufficient (and preferably not an overdose) amount of ink depending on the printing tasks to be performed within a certain timeframe and to be able to optimise the print quality of the printer 1 permanently depending on the actual (average) droplet size calculated by the control unit 16.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of determining the average droplet size of ink droplets released by an ink jet printer, which comprises the steps of:
(a) measuring an amount of ink dosed to at least one ink reservoir of the ink jet printer, said ink reservoir having a substantially predetermined volume,
(b) measuring the ink level within said ink reservoir,
(c) measuring the number of ink droplets released by at least one nozzle of the ink reservoir, and
(d) determining the average ink droplet size based upon the measured values gathered in steps (a) to (c).

2. The method according to claim 1, which further comprises the step of (e) measuring the number of pressure pulses to selectively expel the ink droplets via the nozzle, wherein the average ink droplet size is based upon measured values gathered in steps (a) to (c) and (e), according to step (d).

3. The method according to claim 1 wherein during step (a) the amount of ink dosed to the ink reservoir is measured by counting the number of ink pellets dosed to the ink reservoir, each pellet having a substantially predetermined and identical volume.

4. The method according to claim 1, wherein during step (b) the ink level within the ink reservoir is measured by means of at least one thermistor.

5. The method according to claim 1, wherein during step (c) the number of ink droplets released by said at least one nozzle of the ink reservoir is measured by counting the number of ink droplets released.

6. The method according to claim 1, wherein during step (d) a control unit is used for determining the average droplet size of the ink droplets released by the nozzle of the ink reservoir.

7. The method according to claim 1, wherein the ink within the ink reservoir is heated.

8. A computer program embodied on a computer readable medium and comprising computer executed codes which are adapted for carrying out the method according to claim 1.

9. A computer program embodied on a computer readable medium and comprising computer executed codes which are adapted for carrying out the method according to claim 2.

10. A computer adapted to operating the computer program according to claim 8.

11. A computer adapted to operating the computer program according to claim 9.

12. An ink jet printer comprising:
a print head containing a plurality of nozzles, and ink channels arranged side by side, each nozzle being connected to an ink reservoir via its associated ink channel, and
a device for dispensing ink pellets of substantially predetermined and identical volume to the print head,
wherein the ink jet printer further includes first counting means for counting the number of ink pellets dispensed to the print head, second counting means for counting the number of ink droplets released by the nozzles, detecting means for detecting the ink level within each ink reservoir, and controlling means for determining the average droplet size of ink droplets released by the nozzles based upon measured values gathered by the first counting means, the second counting means, and the detecting means.

13. The ink jet printer according to claim 12, wherein the second counting means are adapted for counting the number of pressure pulses produced to expel the ink droplets via the nozzles.
